(19) United States
(12) Patent Application Publication
(10) Pub. No.: US 2005/0153583 A1
(43) Pub. Date: Jul. 14, 2005

(54) Electric connection box

(75) Inventors: Hideki Kawamura, Ogasa-gun (JP); Noriyoshi Yamazaki, Ogasa-gun (JP); Tomohiro Sugiura, Ogasa-gun (JP); Yasuhito Suzuki, Ogasa-gun (JP)

Correspondence Address: SUGHRUE MION, PLLC, 2100 PENNSYLVANIA AVENUE, N.W., SUITE 800, WASHINGTON, DC, 20037, US

(73) Assignee: YAZAKI CORPORATION

(21) Appl. No.: 11/015,280

(22) Filed: Dec. 20, 2004

(30) Foreign Application Priority Data
Dec. 22, 2003 (JP) P2003-424447

(51) Int. Cl. H01R 12/00

(52) U.S. Cl. 439/76.2

(57) ABSTRACT

In an electric connection box 1, an insulating array bus bar 5 includes a plurality of bus bar bodies 3 covered with an insulative resin portion 4 in an arranged manner, and terminal portions 17 to 23 of the plurality of bus bar bodies project from opposite ends of the insulative resin portion. The terminal portions 17 and 20 at one end of the insulating array bus bar are disposed in electrical part-mounting portions 9 and 10 of a connection box body 2, and the terminal portions 18, 19, 22 and 23 at the other end of the insulating array bus bar, are disposed in a connector block 8, and the connector block is mounted in the connection box body. A plate-like power supply bus bar 6 is disposed in opposed relation to the insulating array bus bar 5, and terminal portions 30, 39 and 40 of the power supply bus bar are disposed in the electrical part-mounting portions 9 and 10 of the connection box body 2, and are connected to the corresponding terminal portions of the insulating array bus bar 5 via electrical parts 12 and 13. The power supply bus bar 6 is fixed to the insulating array bus bar 5 through projected portions 25 formed on the insulative resin portion 4.

### BACKGROUND OF THE INVENTION

1. Field of the Invention

This invention relates to an electric connection box in which two bus bars are joined in opposed relation to each other so that fuses, relays, connectors, etc., can be connected to the electric connection box.

2. Related Art

FIG. 9 shows one conventional electric connection box as shown in Unexamined Japanese Patent Publication Hei. 9-45388.

This electric connection box 71 comprises a synthetic resin-made main cover 72, two bus bars 73 and 74 mounted in a vertical posture within the main cover 72 in parallel relation to each other, and upper and lower covers (not shown) attached respectively to upper and lower sides of the main cover 72.

Cavities 75 for respectively receiving large-current fusible links, as well as cavities 76 for respectively receiving small-current fuses, are formed in an upper portion of the main cover 72. The bus bars 73 and 74 are inserted into the main cover 72 from the lower side thereof, and are retainingly held in the main cover 72 by their retaining projections 77, and their male terminal portions 78 and 79 are connected respectively to terminal portions of the fusible links.

A battery-side terminal and a fuse-side terminal are screw-fastened and connected to terminal portions 80 of one bus bar 73 (formed respectively at opposite ends thereof), respectively, and an alternator-side terminal is fastened and connected to the other bus bar 74 by a bolt 81.

In the above conventional electric connection box 71, however, the bus bars 73 and 74 have only the upwardly-directed terminals 78 and 79, and therefore there has been encountered a problem that the connection form is limited only to the connection of the fusible links, so that this electric connection box can not meet various connection specifications (circuit forms) such as a connector connection form.

And besides, the two bus bars 73 and 74 must be inserted one by one into the main cover 72, and therefore there has been encountered a problem that much time and labor are required for the assembling operation, so that the efficiency of the assembling operation is low. In addition, the opposed terminals 78 and 79 of the two bus bars 73 and 74 are liable to be displaced relative to each other, and in such a case, there has been a fear that their ability of connection to the fusible links or others is lowered.

Furthermore, in order to prevent the short-circuiting between the bus bars 73 and 74, an insulative partition wall need to be formed integrally within the main cover 72, and therefore there has been a fear that the ventilation within the main cover 72 is worsened, so that the bus bars 73 and 74 are heated, thereby adversely affecting the parts (such as the fuses), and there has also been a fear that the structure of the main cover 72, as well as the shape of a mold for forming the main cover, is complicated, so that the cost increases.

### SUMMARY OF THE INVENTION

In view of the foregoing problems, it is an object of this invention to provide an electric connection box which can meet various connection circuit forms and in which the efficiency of an operation for mounting bus bars within a main cover can be enhanced, and also the precision of positioning of terminals of the two bus bars relative to each other can be enhanced, and besides the heat-radiating ability, etc., of the bus bars can be enhanced, and furthermore the moldability of the main cover (connection box body) can be enhanced.

The above object has been achieved by an electric connection box of a first aspect of the present invention of provided in that an insulating array bus bar includes a plurality of bus bar bodies covered with an insulative resin portion in an arranged manner, and terminal portions of the plurality of bus bar bodies project from opposite ends of the insulative resin portion, and the terminal portions at one end of the insulating array bus bar are disposed in electrical part-mounting portions of a connection box body in which electrical parts are mounted, respectively, and the terminal portions at the other end of the insulating array bus bar are disposed in a connector block, and the connector block is mounted in the connection box body.

In this construction, the plurality of bus bar bodies are fixed relative to one another by the insulative resin portion, and are insulated from one another, and also are insulated from the exterior. The insulative resin portion can be molded of a resin, or can be formed by two insulative resin sheets one of which is bonded to front surfaces of the plurality of bus bar bodies while the other sheet is bonded to rear surfaces of these bus bar bodies. The plurality of bus bar bodies are covered with the insulative resin portion, and therefore it is not necessary to provide an insulating partition wall within the connection box body, and therefore the construction of the connection box body is simplified, and besides an increased space within the connection box body can be obtained, so that a ventilation effect is enhanced. The insulating array bus bar is open to the air (This does not mean that the bus bar bodies of the insulating array bus bar are exposed to the air), so that a heat-radiating effect is enhanced. And besides, the terminal portions, projecting from the opposite ends of the insulating array bus bar, are disposed in a common plane, and therefore a process of bending the terminal portions is not necessary, so that the processing of the terminal portions is easy, and also the structure has a compact and space-saving design. The terminals at the one end of the insulating array bus bar are connected to the electrical parts such as fuses, while the terminals at the other end thereof are connected to connectors of a wire harness or the like at the connector block.

The electric connection box of a second aspect of the present invention, depending from the first aspect of the present invention, is provided in that the insulative resin portion is molded.

With this construction, the plurality of bus bar bodies are embedded in the insulative resin portion, with no void formed therein, so that the insulating and waterproof abilities are enhanced.

The electric connection box of a third aspect of the present invention, depending from the first or second aspect of the present invention, is provided in that a plate-like power supply bus bar is disposed in opposed relation to the insulating array bus bar, and terminal portions of the power supply bus bar are disposed in the electrical part-mounting portions of the connection box body, and are connected to the corresponding terminal portions of the insulating array bus bar via the electrical parts.

In this construction, electric power is supplied from the power supply bus bar to the insulating array bus bar via the electrical parts, and electric power is supplied from the terminal potions of the insulating array bus bar to the connectors of the wire harness or the like via the connector block. A space (gap) is formed between the insulating array bus bar and the power supply bus bar, and any partition wall of the connection box body is not disposed within this space (Such a partition wall is not necessary since the insulating array bus bar is insulated by the insulative resin portion), and the radiation of heat from the two bus bars is effected via this space. The power supply bus bar is not insulated, and therefore has a good radiating ability.

The electric connection box of a fourth aspect of the present invention, depending from the third aspect of the present invention, is provided in that the power supply bus bar is fixed to the insulating array bus bar through projected portions formed on the insulative resin portion.

In this construction, the power supply bus bar and the insulating array bus bar are fixed to each other, and the projected portions accurately position the two bus bars relative to each other, so that the precision of positioning of each mating pair of opposed terminal portions of the two bus bars relative to each other in a direction of their width is enhanced, and therefore the connectability of the connecting-side electrical parts and connectors is enhanced. The two bus bars are combined together in a unitary manner, and are mounted within the connection box body.

The electric connection box of the fifth aspect of the present invention, depending from according to the fourth aspect of the present invention, provided in that each of the projected portions has a smaller-diameter distal end portion extending from a stepped portion thereof, and the power supply bus bar has engagement holes in which the smaller-diameter distal end portions are engaged, respectively.

With this construction, the inner surface of the power supply bus bar abuts against the stepped portions of the projected portions disposed immediately adjacent to their respective distal end portions, so that the gap between the power supply bus bar and the insulating array bus bar is accurately set, and also the gap between each mating pair of opposed terminal portions of the two bus bars is accurately set. For example, each smaller-diameter portion is passed through the corresponding hole in the power supply bus bar, and is heated and pressed to be deformed to provide a fixing head of a larger diameter.

The electric connection box of the sixth aspect of the present invention, depending from any one of the third to fifth aspect of the present invention, is provided in that each of the insulating array bus bar and the power supply bus bar is disposed in a vertical posture.

With this construction, an area of projection of the integrally-combined two bus bars from the upper side is small (This is partly due to the fact that the terminal portions of the bus bars are not bent, but extend straight), and the structure of the bus bars is made compact, and therefore can be easily mounted in the connection box body. And besides, the two bus bars are vertically disposed in opposed relation to each other, and heat, generated from the two bus bars, is allowed to efficiently escape upwardly (that is, radiated) through the gap between the two bus bars. Furthermore, even when water drops deposit on the bus bars, the water drops smoothly flow downward along the bus bars because of their own weight, and are discharged.

The electric connection box of the seventh aspect of the present invention, depending from any one of the third to sixth aspect of the present invention, is provided in that a guide wall, formed within the connection box body, is inserted between the insulating array bus bar and the power supply bus bar.

In this construction, when the two bus bars are inserted into the connection box body, the two bus bars, while properly positioned, are smoothly guided along the guide wall. This effect is conspicuous particularly when the two bus bars are fixed together to form the bus bar assembly.

The electric connection box of an eighth aspect of the present invention, depending from any one of the first to seventh aspect of the present invention, is provided in that tabs for part-connecting or -mounting purposes are formed on and project from the insulating array bus bar in a direction of a wall thickness of the insulating array bus bar.

In this construction, for example, electrical parts such as relays are optionally fixedly connected by welding or the like to the tabs which are formed respectively by bent portions of the bus bar bodies, and project in the direction of the thickness of the insulating array bus bar. Each electrical part is disposed in proximity to or in intimate contact with the outer surface of the insulative resin portion, and is insulated from the plurality of bus bar bodies by the insulative resin portion.

The electric connection box of a ninth aspect of the present invention, depending from any one of the first to eighth aspect of the present invention, is provided in that the electrical parts are fuses and fusible links.

In this construction, the terminal portions at one end of the power supply bus bar are connected to the terminal portions at one end of the insulating array bus bar via the fuses and fusible links, and electric power is supplied via these electrical parts and the terminal portions at the other end of the insulating array bus bar to the mating connectors at the connector block, and also electric power is supplied to the relays or others via the tabs recited in the seventh aspect of the present invention. The fuse-connecting terminal portions are narrow, while the fusible link-connecting terminal portions are wide.

The electric connection box of a tenth aspect of the present invention, depending from any one of the first to ninth aspect of the present invention, is provided in that connectors of a wire harness are connected to the connector block.

In this construction, electric power is supplied from the power supply bus bar to the insulating array bus bar via the electrical parts, and the terminal portions of the insulating array bus bar cooperate with the connector block to form connectors, and the connectors of the wire harness are fittingly connected to these connectors, and electric power is supplied from the insulating array bus bar to relays, load-side electrical equipments, auxiliary equipments and others via the wire harness.

In the first aspect of the present invention, the terminal portions at the opposite ends of the insulating array bus bar are connected to the different parts, that is, the electrical parts and the connectors, and with this construction the electric connection box can meet various circuit specifications, and a variety of connection circuit forms can be obtained. And besides, the plurality of bus bar bodies are insulated by the insulative resin portion, and therefore there is no need to provide an insulating partition wall within the connection box body, so that the moldability of the connection box body is enhanced, and in addition the ventilation within the connection box body is enhanced, so that the heat-radiating ability of the insulating array bus bar is enhanced. Furthermore, the terminal portions, projecting from the opposite ends of the insulating array bus bar, are disposed in a common plane, and therefore a process of bending the terminal portions is not necessary, so that the processing of the terminal portions can be effected easily at a low cost, and also the insulating array bus bar, as well as the structure for connecting this bus bar, has a compact and space-saving design, so that the electric connection box can be formed into a compact design.

In the second aspect of the present invention, the plurality of bus bar bodies are embedded in the insulative resin portion, with no void formed therein, so that the insulating and waterproof abilities are enhanced. And besides, the insulative resin portion can be formed rapidly at a low cost, so that productivity of the insulating array bus bars is enhanced.

In the third aspect of the present invention, electric power is supplied from the power supply bus bar to the insulating array bus bar, and electric power is supplied to the mating connectors at the connector block. By doing so, electric power can be supplied to relays, electrical equipments, auxiliary equipments, etc., other than the electrical parts such as fuses, and therefore the electric connection box can meet a variety of circuit connection forms. And besides, heat can be efficiently radiated from the insulating array bus bar and the power supply bus bar via the space between the two bus bars, and therefore the electric connection box is enhanced in durability, and also can meet an increased number of the parts such as fuses and relays. Furthermore, the insulative resin portion is provided at the insulating array bus bar, and therefore it is not necessary to insulate the power supply bus bar, so that the bus bar assembly has the compact and lightweight structure.

In the fourth aspect of the present invention, the two bus bars are fixed together by the projected portions while positioning the two bus bars relative to each other by the projected portions, and therefore the precision of positioning of each mating pair of terminal portions of the two bus bars relative to each other is enhanced, so that the electrical parts can operate with good precision. And besides, the two bus bars can be easily fixed together, utilizing part (projected portions) of the insulative resin portion, so that the efficiency of the operation for assembling the two bus bars together is enhanced. Furthermore, the two bus bars, combined together in a unitary manner, is mounted in the connection box body, and therefore the time and labor, required for mounting the bus bars one by one in the connection box body as in the conventional construction, are saved, so that the efficiency of the operation for mounting the bus bars is enhanced.

In the fifth aspect of the present invention, the gap between the two bus bars is accurately set by the projected portions, and hence the gap between each mating pair of opposed terminal portions of the two bus bars is accurately set. Therefore, the precision of connection of the electrical parts such as fusible links is enhanced. By deforming the distal ends of the projected portions by heating means, the two bus bars can be easily and rapidly fixed together.

In the sixth aspect of the present invention, the projected area of the two bus bars is small, and the structure thereof is made compact, and therefore the two bus bars can be easily mounted in the connection box body, and also the electric connection box can be formed into a compact design. And besides, heat, generated within the electric connection box, is allowed to escape upwardly through the gap between the two bus bars, and therefore the heat-radiating ability is enhanced, and even when water drops deposit on the bus bars, the water drops smoothly flow downward along the vertically-disposed bus bars, and are discharged, so that the durability of the electric connection box is enhanced.

In the seventh aspect of the present invention, the two bus bars are smoothly inserted into the connection box body along the guide wall of the connection box body without deviation, and therefore the efficiency of the operation for assembling the electric connection box is enhanced.

In the eighth aspect of the present invention, relays and other electrical parts are fixed and connected to the tabs projecting perpendicularly from the insulative resin portion, and by doing so, the electric connection box can meet a wide variety of circuit specifications. And besides, by arranging the electrical parts in proximity to or in contact with the outer surface of the insulative resin portion, a space available at the side of the bus bars can be efficiently utilized, and the bus bar assembly of the compact structure can be obtained.

In the ninth aspect of the present invention, electric power is supplied from the power supply bus bar to the bus bar bodies of the insulating array bus bar via the fuses and the fusible links, and electric power is supplied from the bus bar bodies to the mating connectors at the connector block, thus meeting other circuit connection specification than the fuse connection circuit specification.

In the tenth aspect of the present invention, electric power can be supplied from the power supply bus bar to the external wire harness via the insulating array bus bar, thus meeting a variety of circuit connection forms.

### BRIEF DESCRIPTION OF THE DRAWINGS

FIG. 1 is an exploded, perspective view showing one preferred embodiment of an electric connection box of the present invention.

FIG. 2 is a longitudinal cross-sectional view of a main cover of the electric connection box.

FIG. 3 is a perspective view showing one example of a bus bar assembly of the electric connection box.

FIG. 4 is a front-elevational view showing one example of a power supply bus bar of the bus bar assembly.

FIG. 5 is a perspective view showing one example of an insulating array bus bar of the bus bar assembly.

FIG. 6 is a front-elevational view of the insulating array bus bar.

FIG. 7 is a plan view of the bus bar assembly.

FIG. 8 is a perspective view of one example of a connector block of the electric connection box as seen from a lower side thereof.

FIG. 9 is an exploded, perspective view of one conventional electric connection box.

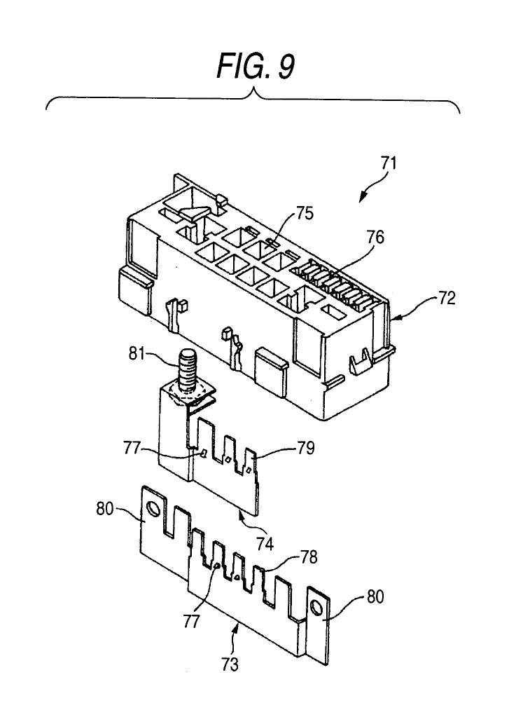

### DETAILED DESCRIPTION OF THE PREFERRED EMBODIMENTS

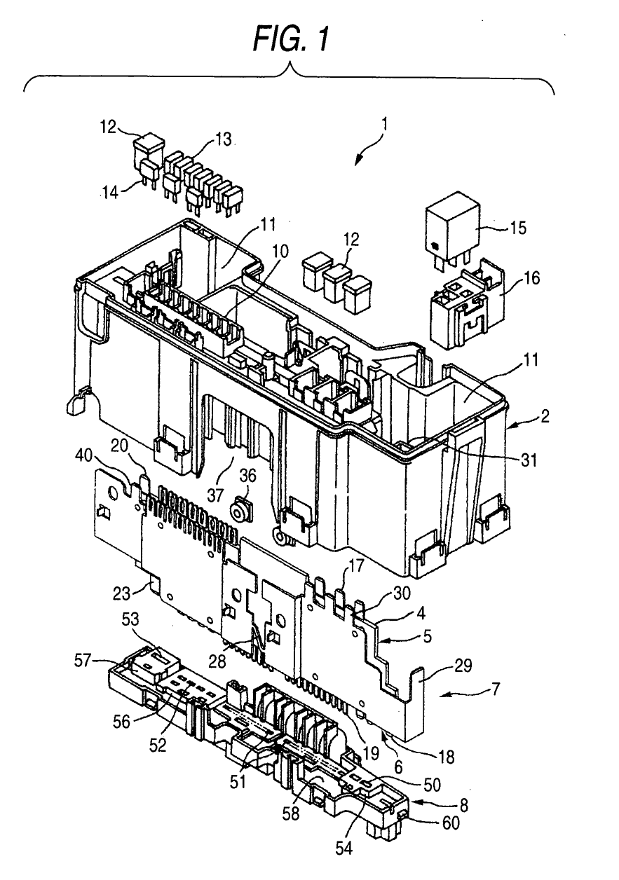

FIG. 1 shows one preferred embodiment of an electric connection box of the present invention.

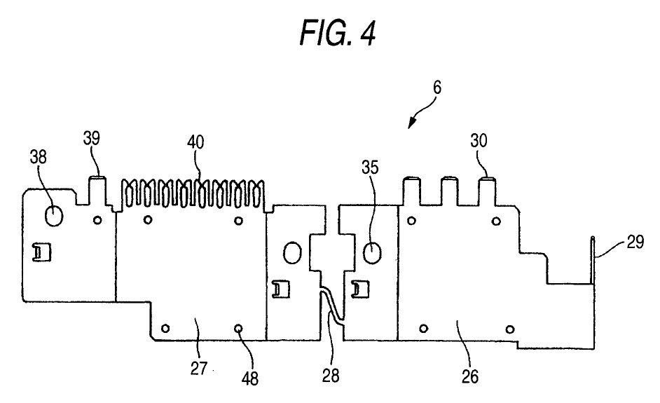

This electric connection box 1 comprises a synthetic resin-made main cover (connection box body) 2, a bus bar assembly 7 (which comprises an insulating array bus bar 5 having a plurality of bus bar bodies 3 (FIG. 4) covered with an insulative resin portion 4, and a flat plate-like power supply bus bar 6 which is exposed to the exterior, and is fixed to the bus bar 5 in opposed relation thereto), a synthetic (insulative) resin-made connector block (undercover) 8 attached to a lower side of the bus bar assembly 7, a synthetic resin-made lower cover (not shown) attached to the lower side of the main cover 2, and a synthetic resin-made upper cover (not shown) attached the upper side of the main cover 2.

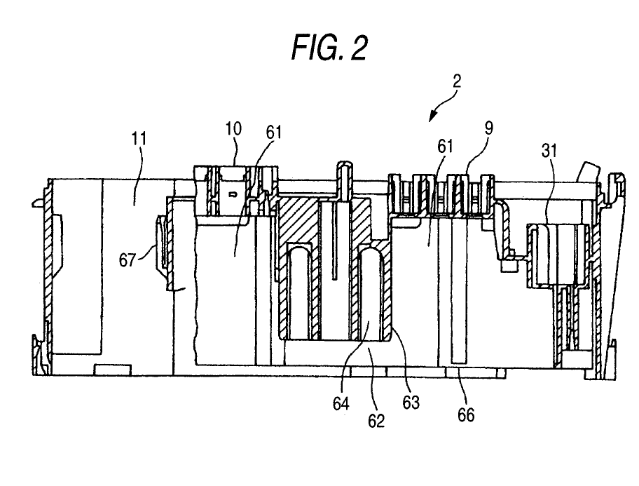

As shown in FIGS. 1 and 2, the main cover 2 includes a plurality of juxtaposed fusible link-mounting portions (electrical part-mounting portions) 9 provided at an upper right half portion thereof, a plurality of juxtaposed fuse-mounting portions (electrical part-mounting portions) 10 provided at an upper left half portion thereof, relay receiving portions 11 provided respectively at right and left end portions thereof, and a connector housing 31 at the right end portion thereof. FIG. 2 is a longitudinal cross-sectional view of the main cover of FIG. 1 (The right half portion and central portion of the main cover are cut at a front side portion thereof, while the left half portion thereof is cut at a central portion thereof.

The fusible link-mounting portions 9 and the fuse-mounting portions 10 communicate with an internal space 61 of the main cover 2. A space within the main cover 2 is divided by a vertical partition wall 62 (FIG. 2) disposed at a central portion of the main cover intermediate the front and rear sides thereof, and the bus bar assembly 7 (FIG. 1) and the connector block 8 are received in the internal space 61 disposed at the front side of the partition wall 62.

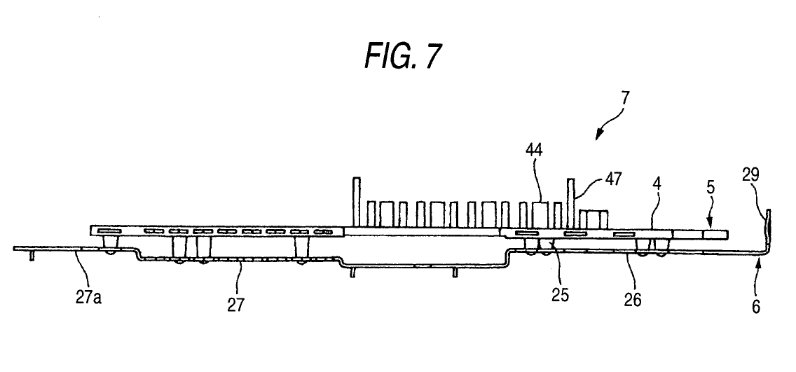

A guide wall 63 for the bus bar assembly 7 is provided at a central portion of the internal space 61 intermediate front and rear sides thereof. This guide wall 63 extends downwardly from an upper wall of the main cover 2, and has guide grooves 64 for respectively receiving nuts 36 (FIG. 1) for fixing a post-mounting fuse (not shown) to the bus bar assembly 7. The guide wall 63 is inserted into a wide gap (space) 65 (FIG. 7) between central portions of the two bus bars 5 and 6 of the bus bar assembly 7 to guide the bus bar assembly 7, thereby enabling the bus bar assembly 7 to be smoothly (easily) and positively inserted into the main cover. The bus bar assembly 7 is inserted upwardly into the main cover 2 through an opening 66 formed in the lower side thereof.

In FIG. 1, each of fusible links 12 has a pair of female terminals (not shown) provided therein, and each of fuses 13 has a pair of male terminals 14. A relay 15 is attached to a cassette relay block 16, and in this condition the relay 15 is mounted in the main cover 2. The relay receiving spaces 11, provided within the main cover 2, extend vertically through this main cover. In FIG. 2, reference numeral 67 denotes a retaining portion for the cassette relay block 16.

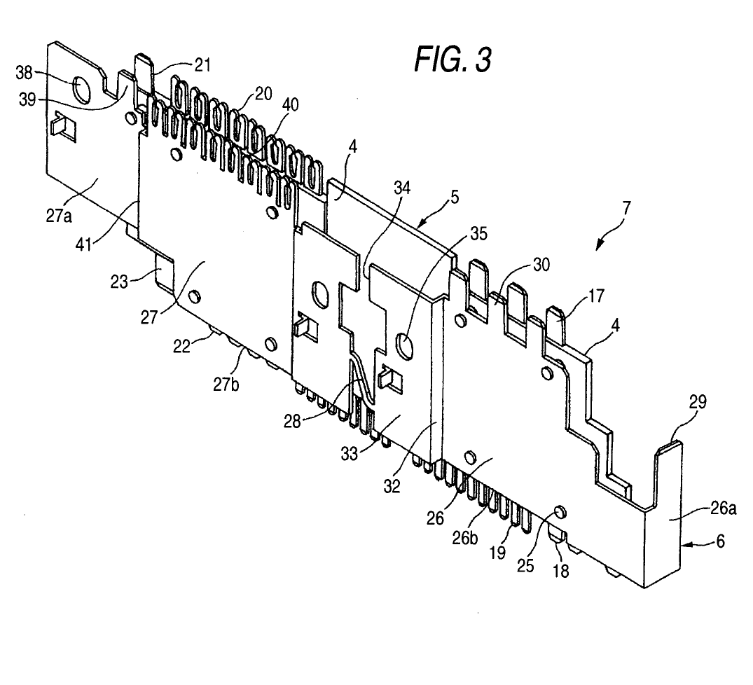

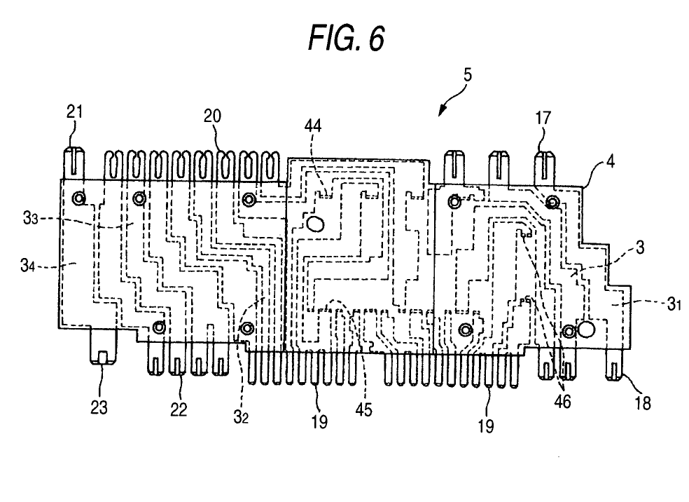

As shown also in FIG. 3, the bus bar assembly 7 comprises the flat plate-like power supply bus bar 6 disposed in a vertical posture, and the insulating array bus bar 5 having the plurality of connecting-purpose bus bar bodies 3 (FIG. 6) covered with the insulative resin portion 4. The power supply bus bar 6 has the exposed front and rear surfaces, and the strip-like bus bar bodies 3 (FIG. 6) of the insulating array bus bar 5 are covered with the insulative resin portion 4 except their terminal portions 17 to 23, and the insulating array bus bar 5 and the power supply bus bar 6 are fixed together in parallel relation to each other by bosses (projected portions) 25 formed integrally on the insulative resin portion 4.

In this embodiment, a right half portion 26 and a left half portion 27 of the power supply bus bar 6 are interconnected by a fuse (melting portion) 28 as shown in FIGS. 3 and 4. The right half portion 26 has a plus-side male terminal 29 formed at its right end, and a plurality of upwardly-projecting male terminals 30 for connection to the respective fusible links 12 (FIG. 1) are formed at an upper portion of the right half portion 26. The plus-side male terminal 29 projects into the interior of the connector housing 31 provided at the right end portion of the main cover 2 (FIG. 1), and is opposed to a minus-side terminal (not shown) (connected, for example, to a wire harness) within the connector housing 31 to form a connector. The right end male terminal 29 lies in a plane in which an end portion 26, bent perpendicularly relative to a flat plate-like bus bar body (designated by reference numeral 26 for convenience), lies. The upper projecting male terminals 30 lie in a plane in which the flat plate-like bus bar body 26 lies. For example, terminal-connected wires (not shown) for supplying electric power from a battery are thread-fastened and connected respectively to hole portions 35 formed in a central portion of the bus bar 6. Alternatively, a power-side wire harness is connected to a connector (designated by reference numeral 31 for convenience) via a connector.

An outwardly-bulging plate-like portion 33 is formed at the central portion of the power supply bus bar 6 through stepped portions 32, and a vertically-extending notch 34 is formed in a central portion of the bulging portion 33. The narrow fuse 28 is formed at this bulging portion, and extends across the notch 34. Whether or not the notch 34 and the fuse 28 are provided is suitably determined in accordance with the kind of car, etc. The bolt insertion holes 35 are formed through the bulging portion 33, and are disposed above the fuse 28. After the fuse 28 melts, the post-mounting (external) fuse (not shown) is connected to the bus bar 6 at these bolt insertion holes 35 by bolts and the nuts 36 (FIG. 1). The bulging portion 33 and the post-mounting fuse are disposed in a central opening 37 in the main cover 2. A cover plate of the lower cover (not shown) can be slidingly engaged in an edge of the opening 37 to close this opening 37.

The left half portion 27 of the power supply bus bar 6 has a hole 38 formed through a left end portion thereof, and for example, an external-connection terminal-connected wire is connected by thread fastening to this hole portion 38. A male terminal 39 to which the fusible link 12 (FIG. 1) is connected is formed at the left end portion of the left half portion 27. A plurality of tuning fork-like gripping terminals 40 are formed at an upper portion of the left half portion 27, and project upwardly (vertically). The projecting terminal portions 40 lie in a plane in which a flat plate-like bus bar body (designated by reference numeral 27 for convenience) lies. A left end portion 27a, having the hole 38 and the male terminal 39, is offset inwardly via a stepped portion 41, and is disposed parallel to the flat plate-like bus bar body 27.

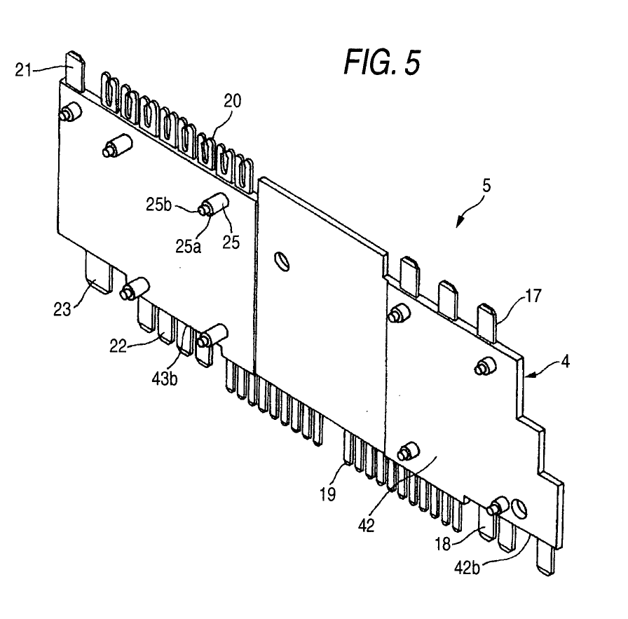

FIGS. 5 and 6 show the connecting-purpose insulating array bus bar 7, and the plurality of bus bar bodies 3 (FIG. 6) are arranged in a common plane in the flat plate-like insulative resin portion 4, and the terminal portions 17, 20 and 21 project upwardly from the insulative resin portion 4, while the terminal portions 18, 19, 22 and 23 project downwardly from the insulative resin portion 4. The fusible link connecting-male terminals 17 project from an upper end (edge) of a right half portion 42 of the insulative resin portion 4, and are arranged at equal intervals. The plurality of connecting-purpose tuning fork-like gripping terminals 20 and one fusible link-connecting male terminal 21 project from an upper end (edge) of a left half portion 43 of the insulative resin portion 4, and many (connector connecting-purpose) narrow male terminals 19 and a few (connector connecting-purpose) wide male terminals 18 project from a lower end (edge) of the insulative resin portion 4.

As shown in FIG. 6, each of bus bar bodies 3₁ at the right end portion of the insulating array bus bar 7 is continuous with the corresponding upper and lower wide male terminals 17 and 18 such that the bus bar body 3₁ and these terminals 17 and 18 are disposed in a common plane. Each of narrow bus bar bodies 3₂ at the central portion of the insulating array bus bar 5 is continuous with the corresponding lower narrow male terminal 19 and the upper gripping terminal 20 such that the bus bar body 3₂ and these terminals 19 and 20 are disposed in a common plane. Like part of the upper gripping terminals 20, part of the bus bar bodies 32 are continuous with respective short tabs (male terminals) 44 and 45 and press-contacting terminals 46 (which project horizontally in the direction of the wall thickness of the insulative resin portion 4 intermediate the upper and lower edges thereof) in perpendicular relation thereto.

Electrical parts (not shown) such as a relay can be optionally connected by soldering or attached to the horizontally-projecting tabs 44 and 45. Wires (not shown) can be optionally connected to the press-contacting terminals 46 to connect the bus bar bodies 3 together. A pair of part-fixing ribs 47 (FIG. 7) are formed integrally on and project from the insulative resin portion 4, and are disposed respectively at opposite sides of a region where the upper and lower tabs 44 and 45 are provided.

Each of bus bar bodies 3₃ at the left end portion of the insulative resin portion 4 is continuous with the corresponding upper gripping terminal 20 and lower male terminal 22 such that the bus bar body 3₃ and these terminals 20 and 22 are disposed in a common plane. A bus bar body 3₄ is continuous with the upper wide male terminal 21 and the lower wide male terminal 23 such that the bus bar body 3₄ and these terminals 21 and 23 are disposed in a common plane.

As shown in FIG. 5, the terminals 17 to 23 project from the insulative resin portion 4 in such a manner that these terminals 17 and 23 are disposed generally centrally of the thickness of the insulative resin portion 4. It is preferred from the viewpoint of productivity that the bus bar bodies 3 be insert molded in the insulative resin portion 4 to be covered therewith. However, instead of such insert molding, there can be effectively used a method in which a pair of front and rear insulative resin sheets are bonded together in a direction of their thickness, with the plurality of bus bar bodies 3 sandwiched therebetween, thereby holding and fixing the bus bar bodies 3. In this case, preferably, bosses (not shown) are formed on one of the two insulative resin sheets, while holes (not shown) are formed in the other insulative resin sheet, and when the two insulative resin sheets are to be combined together, the bosses are fitted respectively into the holes, thereby positioning the two insulative resin sheets relative to each other.

As shown in FIG. 5, the plurality of positioning and fixing-purpose bosses (projected portions) 25 are formed on the inner surfaces of the right and left half portions 42 and 43 of the insulative resin portion 4 except the central portion thereof. The boss 25 is formed into a cylindrical shape, and includes a stepped portion 25a formed adjacent to its distal end portion, and a smaller-diameter (distal end) portion 25b extending from this stepped portion 25a. The smaller-diameter portions 25b of the bosses 25 are passed respectively through holes 48 (FIG. 4) in the power supply bus bar 6 as shown in FIG. 3, and the stepped portion 25a of each boss 25 abuts against the inner surface of the power supply bus bar 6, and in this condition the smaller-diameter portion 25b, projecting from the front surface of the bus bar 6, is thermally deformed by thermal pressing or the like to provide a head portion of a larger diameter, thereby fixing the insulating array bus bar 5 and the power supply bus bar 6 together in an accurately positioned manner.

Since the two bus bars 5 and 6 are accurately positioned relative to each other, the two bus bars 5 and 6 are opposed to each other without misregistration. Particularly, the pair of male terminals 14 of each fuse 13 (FIG. 1) are inserted respectively into the corresponding pair of gripping terminals 20 and 40 (FIG. 3) in perpendicularly-intersecting relation thereto, and therefore if the gripping terminals 20 and 40 are disposed out of registry with each other, the electrical contact of the fuse 13 is liable to be incomplete. However, the gripping terminals 20 and 40 are positioned relative to each other with high precision, and therefore such a trouble is positively prevented.

Further, by accurately setting the length of that portion of the boss 25 (FIG. 5) extending from its proximal end to its stepped portion 25a, the gap between each pair of male terminals 17 and 30 of the two bus bars 5 and 6, as well the gap between the pair of male terminals 21 and 39, can be accurately set, and particularly the precision of connection of the terminals to the fusible links 12 (FIG. 1) is enhanced.

FIG. 7 is a plan view showing a condition in which the insulating array bus bar 5 is fixedly connected to the power supply bus bar 6 through the bosses 25. In accordance with the distance between the inner surface of the insulative resin portion 4 and the right half portion 26 of the power supply bus bar 6, the distance between this inner surface and the left half portion 27 of the bus bar 6 and the distance between this inner surface and the left end portion 27a of the bus bar 6, the lengths of the bosses 25 are so determined that the two bus bars 5 and 6 are held parallel to each other by the bosses 25. The male terminal 29 of the power supply bus bar 6 is disposed in opposed relation to the right end (edge) of the insulating array bus bar 5, and the left end portion 27a of the power supply bus bar 6 extends left beyond the left end (edge) of the insulating array bus bar 6.

A lower end (edge) 26b of the right half portion 26 of the power supply bus bar 6 of FIG. 3 and a lower end (edge) 27b of the left half portion 27 thereof are disposed at the same level or height as a lower end (edge) 42b of the right half portion 42 of the insulative resin portion 4 and a lower end (edge) 43b of the left half portion 43 thereof, and at least these lower ends are held against and supported by the upper surface of the connector block 8.

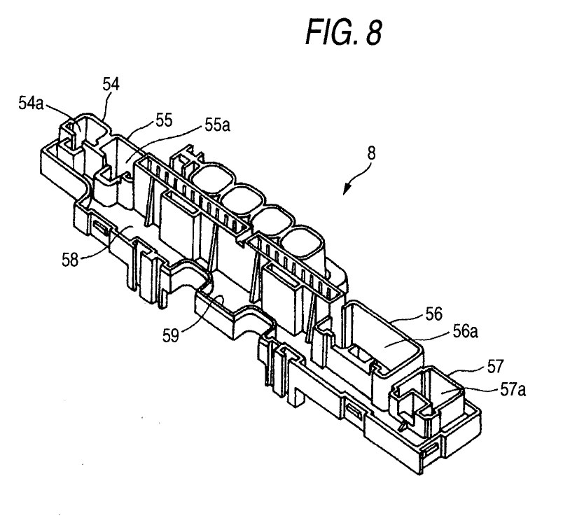

As shown in FIG. 1 (showing the connector block 8 as seen from the upper side) and FIG. 8 (showing the connector block as seen from the lower side), the connector block 8 includes slit-like holes 50 to 53 for respectively receiving the downwardly-projecting male terminals 18, 19, 22 and 23 (FIG. 5), and the holes 50 to 53 communicate with respective connector fitting chambers 54a to 57a of connector housings 54 to 57 (FIG. 8). The connector housings 54 to 57 are formed integrally on and project from a horizontal base wall 58 of the connector block 8. The outer periphery of the base wall 58 is surrounded by a frame-like portion 59.

The wide male terminals 18, 22 and 23 at the right and left half portions of the insulating array bus bar 5 project into the four connector housings 54, 55, 56 and 57 at right and left half portions of the connector block 8 to form connectors, and the narrow male terminals 19 at the central portion of the insulating array bus bar 5 project into the two connector housings 51 at a central portion of the connector block 8 to form connectors. Connectors (not shown) of a wire harness are fittingly connected respectively to these connectors within the lower cover (not shown) of the electric connection box 1, and the wire harness is connected to the relays 15 within the main cover 2, and is led out of the electric connection box through an opening in the lower cover, and is connected to load-side electrical equipments, auxiliary equipments, etc.

The connector block 8 is inserted into the main cover 2 through the lower opening of this main cover 2, and is retained relative to the main cover 2 by retaining means comprising retaining projections 60 and engagement recess portions. The lower end of the connector block 8 is disposed generally at the same level or height as the lower end of the main cover 2.

After the bus bar assembly 7 is attached to the connector block 8, the connector block 8 is mounted in the main cover 2. Alternatively, after the bus bar assembly 7 is inserted (mounted) in the main cover 2, the connector block 8 is inserted into the main cover 2, and is combined with the bus bar assembly 7. The connector block 8 and the bus bar assembly 7 are not fixed to each other by retaining means or the like, and the male terminals 18, 19 22 and 23 of the insulating array bus bar 5 are merely inserted in the respective holes 50 to 53 formed in the bottom walls of the connector housings 54 to 57.

Each pair of opposed male terminals 17 and 30 at the upper end of the right half portion of the bus bar assembly 7 are disposed within the corresponding fusible link-mounting portion (housing) 9 at the right half portion of the main cover 2. Each pair of opposed gripping terminals 20 and 40 at the upper end of the left half portion of the bus bar assembly 7 are disposed within the corresponding fuse-mounting portion (housing) 10 at the left half portion of the main cover 2.

Each fusible link 12 is connected to the corresponding pair of male terminals 17 and 30 at the upper end of the right half portion of the bus bar assembly 7, and electric power is supplied from each male terminal 30 of the power supply bus bar 6 via the fusible link 12 and the male terminal 17 (of the insulating array bus bar 5) to the lower (connector-connecting) male terminal 18, thereby supplying electric power to the large-current relay or the load connected to the wire harness. Electric power is supplied to each gripping terminal 40 at the left half portion of the power supply bus bar 6 while decreasing the voltage by the fuse 28 (provided at the central portion of the power supply bus bar 6) serving as a resistance, and further electric power is supplied from the gripping terminal 40 via the fuse 13 and the gripping terminal 20 (of the insulating array bus bar 5) to the lower (connector-connecting) male terminal 19, 22 (FIG. 6), thereby supplying electric power to the small-current fuse or the load connected to the wire harness.

In the above embodiment, although the two bus bars 5 and 6 are arranged parallel to each other, there can be used, for example, a construction in which only the insulating array bus bar 5 is received within the main cover (connection box body) 2, and is connected to the fuse 12 and 13 and the connectors of the connector block 8. In this case, for example, the power-side circuit may be connected directly to the insulating array bus bar 5. In the above embodiment, although the two bus bars 5 and 6 are fixed to each other through the insulative resin portion 4, there can be used a construction in which the two bus bars 5 and 6 are not fixed together by the insulative resin portion 4, and instead the two bus bars 5 and 6 are fixed in opposed relation to each other by retaining means provided at the connection box body 2. The opposed bus bars 5 and 6 do not always need to be disposed in a vertical posture, but can be disposed in a horizontal posture or an inclined posture.

The cylindrical bosses 25, defining the respective projected portions of the insulative resin portion 4, can be replaced by ribs or the like. The bosses or the ribs do not always need to be fixed to the power supply bus bar 6 by thermal fastening, but can be fixed thereto by screws.

1. An electric connection box comprising:
an insulating array bus bar including:
a plurality of bus bar bodies covered with an insulative resin portion in an arranged manner, and terminal portions of said plurality of bus bar bodies projecting from opposite ends of said insulative resin portion, and the terminal portions at one end of said insulating array bus bar being disposed in electrical part-mounting portions of a connection box body in which electrical parts are mounted, respectively, and the terminal portions at the other end of said insulating array bus bar being disposed in a connector block, and said connector block is mounted in said connection box body.

2. An electric connection box according to claim 1, wherein said insulative resin portion is molded.

3. An electric connection box according to claim 1, further comprising:
a plate-like power supply bus bar disposed in opposed relation to said insulating array bus bar, and terminal portions of said power supply bus bar being disposed in the electrical part-mounting portions of said connection box body, and being connected to the corresponding terminal portions of said insulating array bus bar via the electrical parts.

4. An electric connection box according to claim 3, wherein said power supply bus bar is fixed to said insulating array bus bar through projected portions formed on said insulative resin portion.

5. An electric connection box according to claim 4, wherein each of said projected portions has a smaller-diameter distal end portion extending from a stepped portion thereof, and said power supply bus bar has engagement holes in which said smaller-diameter distal end portions are engaged, respectively.

6. An electric connection box according to claim 3, wherein each of said insulating array bus bar and said power supply bus bar is disposed in a vertical posture.

7. An electric connection box according to claim 3, further comprising:
a guide wall, formed within said connection box body, inserted between said insulating array bus bar and said power supply bus bar.

8. An electric connection box according to claim 1, further comprising:
tabs for part-connecting or part-mounting formed on and project from said insulating array bus bar in a direction of a wall thickness of said insulating array bus bar.

9. An electric connection box according to claim 1, wherein said electrical parts are fuses and fusible links.

10. An electric connection box according to claim 1, wherein connectors of a wire harness are connected to said connector block.
